(19) United States
(12) Patent Application Publication
(10) Pub. No.: US 2014/0353194 A1
(43) Pub. Date: Dec. 4, 2014

(54) MEMORY WIRE WITH CANVAS OR FLEXIBLE SHEET SIGNAGE

(71) Applicant: Harvey Reese, Philadelphia, PA (US)

(72) Inventor: Harvey Reese, Philadelphia, PA (US)

(21) Appl. No.: 13/906,936

(22) Filed: May 31, 2013

(51) Int. Cl. G09F 15/00; B44D 3/18

(52) U.S. Cl. CPC G09F 15/00; B44D 3/18; G09F 2015/0093
USPC 206/449

(57) ABSTRACT

A device includes a memory wire frame disposed internally of an artists' canvas, display, or sign. The memory wire can be a round wire shape, and can be a flat wire shape. The memory wire frame can be assembled with the artists' canvas, display, or sign, then rolled up into a rolled-up configuration, and then secured in the rolled up configuration. The rolled-up artists' canvas, display, or sign can be secured, for example, by elastic straps, string, ribbon, rubber bands, flexible plastic or metal straps, or by being placed in a tube such as a conventional mailing tube. When unsecured, the memory wire restores the device to a flat configuration, ready for display and/or use.

### CROSS REFERENCE TO RELATED APPLICATIONS

Not applicable.

### STATEMENT REGARDING FEDERALLY SPONSORED RESEARCH OR DEVELOPMENT

Not applicable.

### FIELD OF THE INVENTION

The present invention relates to artists' canvases, displays and signs. More specifically, the present invention relates to a memory wire frame useful for such artists' canvases, displays and signs.

### BACKGROUND OF THE INVENTION

It is a problem in the art to conveniently transport an artists' canvas, display, or sign, without taking up a large amount of space and without risking damage thereto during transport or storage.

Also, it is known to roll up an artists' canvas, display, or signs, but unrolling and framing such articles can be difficult and time consuming.

There is a need for an artists' canvas, display, or sign that can be rolled up for transport and/or storage, yet is easily unrolled and made to stay in a flat conformation for ease of use and/or display.

### SUMMARY OF THE INVENTION

From the foregoing, it is seen that it is a problem in the art to provide a device meeting the above requirements. According to the present invention, a device is provided which meets the aforementioned requirements and needs in the prior art. Specifically, the device according to the present invention provides an artists' canvas, display, or sign, which does not take up a large amount of space and reduces the risk of damage thereto during transport or storage.

The present invention provides an artists' canvas, display, or sign that can be rolled up for transport and/or storage, yet is easily unrolled and made to stay in a flat conformation for ease of use and/or display.

The device of the present invention includes a memory wire frame disposed internally of the artists' canvas, display, or sign. The memory wire can be a round wire shape, and can be a flat wire shape. The memory wire frame can be assembled with the artists' canvas, display, or sign, then rolled up into a rolled-up configuration, and then secured in the rolled up configuration. The rolled-up artists' canvas, display, or sign can be secured, for example, by elastic straps, string, ribbon, rubber bands, flexible plastic or metal straps, or by being placed in a tube such as a conventional mailing tube.

When unsecured, the memory wire restores the artists' canvas, display, or sign to a flat configuration, ready for display and/or use.

Other objects and advantages of the present invention will be more readily apparent from the following detailed description when read in conjunction with the accompanying drawings.

### BRIEF DESCRIPTION OF THE DRAWINGS

FIG. 1 is an elevational view of a rear side of an artists' canvas, display, or sign with a memory wire frame disposed thereon, prior to assembly into a finished article, according to the present invention.

FIG. 2 is an elevational view of the artists' canvas, display, or sign with a memory wire frame of FIG. 1, folded and secured into a finished article, according to the present invention.

FIG. 3 shows a rolled-up configuration of the finished article of FIG. 2, secured for ease of storage or transport.

FIG. 4 shows a front elevational view of the finished article of FIG. 2, in an unrolled configuration wherein the artists' canvas, display, or sign has a substantially flat conformation suitable for display.

FIG. 5 shows an alternative embodiment of the memory wire frame, assembled from two opposed memory wire portions and two opposed rigid portions.

FIG. 6 shows another embodiment of the memory wire frame, showing assembly from two opposed memory wire portions and two opposed rigid portions, wherein the memory wire has a flat configuration and is to be secured into grooves or slots formed in the two opposed rigid portions.

FIG. 7 shows the embodiment of the memory wire frame of FIG. 6, showing the assembled memory wire frame having two opposed memory wire portions and two opposed rigid portions, wherein the memory wire has a flat configuration and is secured in grooves or slots formed in the two opposed rigid portions.

### DETAILED DESCRIPTION OF THE INVENTION

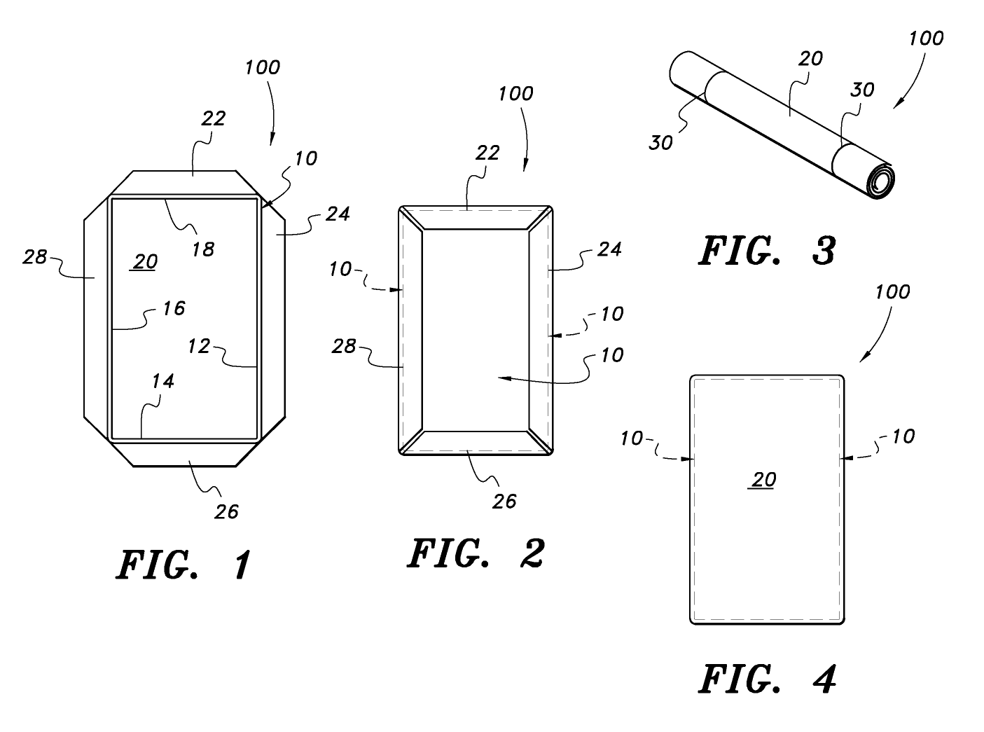

FIG. 1 shows a device 100, and is an elevational view of a rear side of a sheet-like portion 20—Which can be an artists' canvas, display, or sign—having flaps 22, 24, 26 and 28. A memory wire frame 10 is disposed on top of the sheet-like portion 20, prior to assembly into a finished article. The memory wire forming the memory wire frame in the preferred embodiment is a tempered spring steel memory alloy, which is referred to hereafter by the term “memory wire”. Thus, in the preferred embodiment, the wire frame 10 is a tempered spring steel memory alloy wire frame 10, referred to hereafter by the term “memory wire frame 10”.

An important use of the device 100 having the memory wire frame 10 is for artists. An artist, in order to paint on typical canvas—and then to be able to frame the completed painting—must first stretch and nail or staple the canvas onto wood stretchers; which is costly and time consuming. And it he/she is painting outdoors, he/she is limited in size because of transporting difficulties. The present invention solves these problems. The need for wooden stretchers is eliminated because the artist buys the canvas already stretched onto the memory wire, ready to paint and then frame—and since the canvas can be rolled for transporting, the size for outdoor painting is not as restrictive. This is, of course, in addition to the benefits of storage and shipping.

FIG. 2 shows an elevational view of the device 100 as a finished article, wherein the flaps 22, 24, 26, and 28 are folded over the memory wire frame 10. The flaps 22, 24, 26, and 28 are secured by any appropriate securement means suitable for the materials used, such as adhesive, glue, ultrasonic welding, and tape, for example.

The device 100 includes the memory wire frame 10 disposed internally of an artists' canvas, display, or sign 20. The memory wire of the frame 10 can be a round wire shape, or can be a flat wire shape. The memory wire frame 10 can be assembled with the artists' canvas, display, or sign 20, then rolled up into a rolled-up configuration, and then secured in the rolled up configuration (shown in FIG. 3).

FIG. 3 shows a rolled-up configuration of the finished article 100 of FIG. 2, secured for ease of storage or transport. The rolled-up artists' canvas, display, or sign 20 can be secured, for example, by securement means 30. The securement means 30 can include elastic straps, string, ribbon, rubber bands, flexible plastic or metal straps, or by being placed in a tube such as a conventional mailing tube. A single such securement member 30, or a plurality of two or more such securement members 30, can be used. When unsecured, the memory wire of the memory wire frame 10 restores the device 100 to a flat configuration, ready for display and/or use (shown in FIG. 4).

FIG. 4 shows a front elevational view of the finished article 100 of FIG. 2, in an unrolled configuration wherein the artists' canvas, display, or sign 20 has a substantially flat conformation suitable for display.

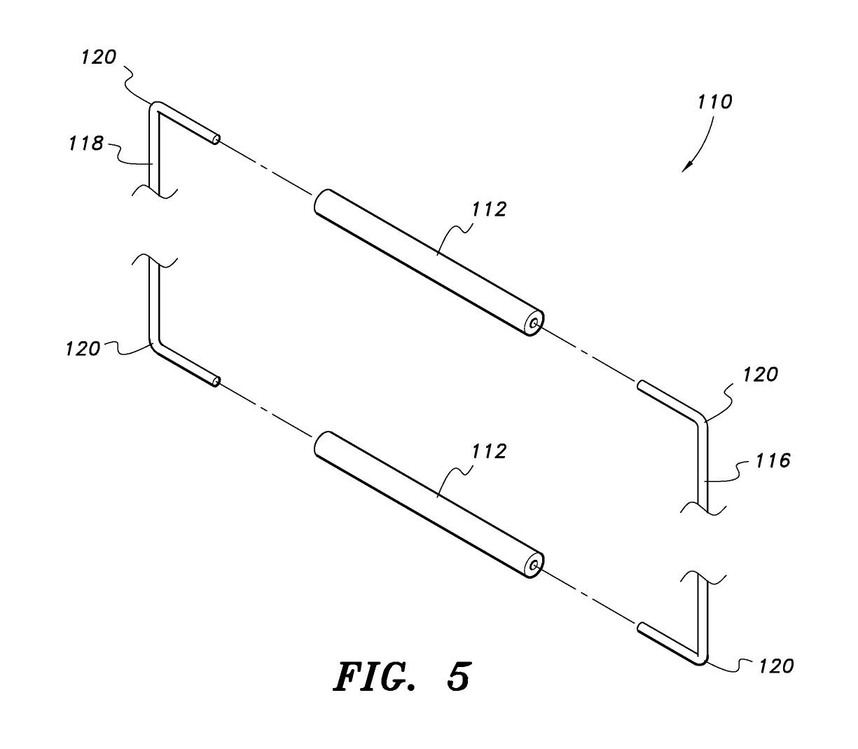

FIG. 5 shows an alternative embodiment of the memory wire frame 20, assembled from two opposed U-shaped memory wire portions 116 and 118, and two opposed rigid portions 112, 112. The wire portions 116 and 118 have bent corners 120. In this view, the rigid portions 112, 112 each have opposed ends which have bores or holes therein adapted to receive the legs of the U-shaped memory wire portions 116 and 118. The bores or holes are contemplated as having shapes corresponding to the cross sectional shape of the memory wire portions, for example rectangular memory wire would be received in a rectangular bore or hole.

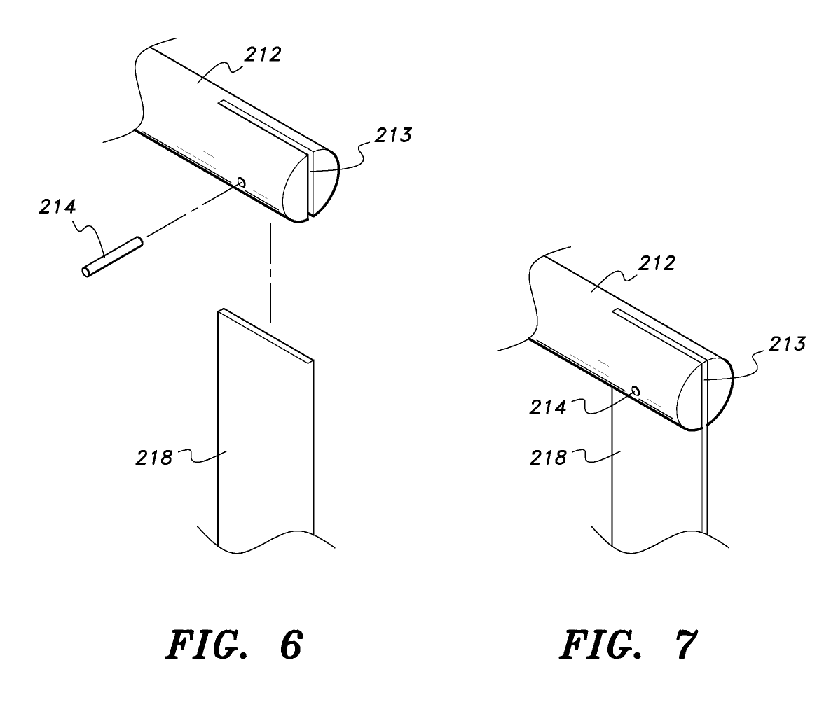

FIG. 6 shows another embodiment of the memory wire frame 20, showing assembly from two opposed memory wire portions 218 and two opposed rigid portions 212, wherein the memory wire portion 218 has a flat configuration and is to be secured into grooves or slots 213 formed in the two opposed rigid portions 212. A nail or pin 214 is inserted or hammered into the rigid portion 212 in the region of the slot 213.

FIG. 7 shows an assembled joint from the elements shown in FIG. 6. The nail 214 is shown fully inserted into the rigid portion 212 to secure the memory wire portion 218 into the slot 213. This view is typical of the four corners of the frame, which would include two opposed memory wire portions 218 and two opposed rigid portions 212.

The memory wire used in the present invention is preferably a spring tempered stainless steel material that automatically returns to its original shape from a bent or deformed configuration. Such shape memory materials are known in the materials science arts, and it is contemplated that any shape memory materials deemed suitable by any one having skill in the memory materials sciences could be used in the present invention; and all such variations are contemplated as being within the scope of the present invention.

The invention being thus described, it will be evident that the same may be varied in many ways by a routineer in the applicable arts. Such variations are not to be regarded as a departure from the spirit and scope of the invention and all such modifications are intended to be included within the scope of the claims.

What is claimed is:

1. An article having a flat configuration and a rolled-up configuration, comprising:
a frame composed of a memory material;
a sheet secured to said frame, forming an assembled article;
said assembed article having a rolled-up configuration and having a flat configuration, wherein said assembled article returns to said flat configuration from said rolled-up configuation when unrestained.

2. An article as claimed in claim 1, wherein said memory material is in the form of a round wire.

3. An article as claimed in claim 1, wherein said memory material is in the form of a relatively flat wire having a substantially rectangular cross section.

4. An article as claimed in claim 1, wherein said finished article is assembled by folding over edges of said sheet around said frame.

5. An article as claimed in claim 1, wherein said sheet is selected from any of an artists' canvas, a display, and sign.

6. An article as claimed in claim 1, further comprising securement means for securing the finished article into said rolled-up configuration.

7. An article as claimed in claim 1, further comprising securement means for securing the finished article into said rolled-up configuration, said securement means being selected from any of flexible bands, ribbon, string, elastic, rubber bands, and straps.

8. An article as claimed in claim 1, wherein said frame comprises two opposed memory wire portions and two opposed rigid portions.

9. An article as claimed in claim 8, wherein the two opposed memory wire portions are flat, and wherein said two opposed rigid portions each have opposed ends with slots therein adapted to receive ends of the flat opposed memory wire portions.

10. An artists' canvas article having a flat configuration and a rolled-up configuration, comprising:
a frame composed of a memory material;
an artists' canvas sheet secured to said frame, forming an assembled article;
said assembed article having a rolled-up configuration and having a flat configuration, wherein said assembled article returns to said flat configuration from said rolled-up configuation when unrestained;
whereby said assembled article can be pre-made, stored, and sold to artists for use in painting.
